(19) United States
(12) Patent Application Publication
(10) Pub. No.: US 2014/0201778 A1
(43) Pub. Date: Jul. 17, 2014

(54) METHOD AND SYSTEM OF INTERACTIVE ADVERTISEMENT

(71) Applicant: Gretta Hohl, Berlin (DE)

(72) Inventor: Gretta Hohl, Berlin (DE)

(73) Assignee: SAP AG, Walldorf (DE)

(21) Appl. No.: 13/834,845

(22) Filed: Mar. 15, 2013

Related U.S. Application Data
(60) Provisional application No. 61/752,845, filed on Jan. 15, 2013.

(51) Int. Cl. H04N 21/81

(52) U.S. Cl. CPC H04N 21/812
USPC 725/32

(57) ABSTRACT

A method and system of associating assets with motion pictures are disclosed. A plurality of asset identifiers may be caused to be displayed on a device. Each asset identifier may identify a distinct asset available for use in a motion picture. A user may be enabled to associate one of the asset identifiers with a motion picture identifier, forming an association between the one of the asset identifiers and the motion picture identifier. The motion picture identifier may identify the motion picture. The association between the one of the asset identifiers and the motion picture identifier may be stored on a storage device. The motion picture may be a feature film or a television episode.

### CROSS-REFERENCE TO RELATED APPLICATIONS

This application claims priority to U.S. Provisional Application No. 61/752,845, filed on Jan. 15, 2013, and entitled, “PLATFORM FOR ASSOCIATING ASSETS WITH MOTION PICTURES,” which is hereby incorporated by reference in its entirety as if set forth herein.

### TECHNICAL FIELD

The present application relates generally to the technical field of data processing, and, in various example embodiments, to methods and systems of associating assets with motion pictures.

### BACKGROUND

Motion picture producers use assets to make motion pictures. There are currently no solutions for interactive advertisement that focus on collaboration between motion picture producers and asset providers.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram illustrating a client-server system, in accordance with an example embodiment;

FIG. 2 is a block diagram illustrating enterprise applications and services as embodied in an enterprise application platform, in accordance with an example embodiment;

FIG. 3 is a block diagram illustrating an asset association system, in accordance with an example embodiment;

FIG. 4 illustrates a mapping of assets to a scene of a motion picture, in accordance with an example embodiment;

FIG. 5 illustrates another mapping of assets to a motion picture, in accordance with an example embodiment;

FIG. 6 is a flowchart illustrating a method of associating assets with a motion picture, in accordance with an example embodiment; and

FIG. 7 is a block diagram of an example computer system on which methodologies described herein may be executed, in accordance with an example embodiment.

### DETAILED DESCRIPTION

Example methods and systems of associating assets with motion pictures are described. In the following description, for purposes of explanation, numerous specific details are set forth in order to provide a thorough understanding of example embodiments. It will be evident, however, to one skilled in the art that the present embodiments may be practiced without these specific details.

In some embodiments, a centralized platform may connect motion picture producers, asset providers, and end-users, thus providing each of them with valuable information. Through this information, motion picture producers and asset providers can collaborate to create offers and make deals about product usage in the films, while end-users can access asset information in real-time or on-demand. This platform may provide a new source of revenue for motion picture producers, thus reducing the need for commercial breaks during broadcasting. Furthermore, it may promote sharing of customers between motion picture and asset industries. This system may create a new market opportunity for software-as-a-service (SaaS) providers, which may create this virtual interactive platform and connect a large number of motion picture producers and asset providers.

For the purposes of the present disclosure, the term “motion picture” may refer to any visual media comprising a series of images configured to produce the optical effect of a continuous picture in which the objects move. Examples of a motion picture may include, but are not limited to, a feature film and a television episode. It is contemplated that other types of motion pictures are also within the scope of the present disclosure. For the purposes of the present disclosure, the term “asset” may refer to any product or service that can be seen or reflected in a motion picture. Examples of assets may include, but are not limited to, articles of clothing, shoes, accessories, furniture, locations (e.g., travel spots, spas, hairdressers), film sets, vehicles, and consumer electronics. It is contemplated that other types of assets are also within the scope of the present disclosure.

In some embodiments, a computer-implemented method may comprise causing a plurality of asset identifiers to be displayed on a device. Each asset identifier may identify a distinct asset available for use in a motion picture. A user may be enabled to associate one of the asset identifiers with a motion picture identifier, thereby forming an association between the one of the asset identifiers and the motion picture identifier, the motion picture identifier identifying the motion picture. The association between the one of the asset identifiers and the motion picture identifier may be stored on a storage device. In some embodiments, enabling the user to associate one of the asset identifiers with a motion picture identifier may comprise enabling the user to associate one of the asset identifiers with at least one structural element of the motion picture. In some embodiments, the at least one structural element may comprise at least one of a scene in the motion picture, an actor in the motion picture, and a location in the motion picture. In some embodiments, the method may further comprise enabling a user to identify the at least one structural element of the motion picture identifier. In some embodiments, the method may further comprise automatically identifying the structural element(s) of the motion picture by analyzing a script uploaded by the user. Formatting or language may be used as an indication of the at least one structural element. In some embodiments, the method may further comprise causing the association of the one of the asset identifiers and the motion picture identifier to be displayed on a device. In some embodiments, the method may further comprise enabling a different user to search for and view details of the distinct assets corresponding to the asset identifiers. In some embodiments, the method may further comprise storing metadata about the asset for the one of the asset identifiers. In some embodiments, the metadata may comprise at least one of an origin of the asset, a price for the asset, and a usage history for the asset. In some embodiments, the motion picture may be a feature film or a television episode.

In some embodiments, a system may comprise a machine having at least one processor, and an asset association module on the machine. The asset association module may be configured to cause a plurality of asset identifiers to be displayed on a device. Each asset identifier may identify a distinct asset available for use in a motion picture. The asset association module may also be configured to enable a user to associate one of the asset identifiers with a motion picture identifier, thereby forming an association between the one of the asset identifiers and the motion picture identifier. The motion picture identifier may identify the motion picture. The asset association module may be further configured to store the association between the one of the asset identifiers and the motion picture identifier on a storage device. In some embodiments, enabling the user to associate one of the asset identifiers with a motion picture identifier may comprise enabling the user to associate one of the asset identifiers with at least one structural element of the motion picture. In some embodiments, the at least one structural element may comprise at least one of a scene in the motion picture, an actor in the motion picture, and a location in the motion picture. In some embodiments, the asset association module may be further configured to enable a user to identify the at least one structural element of the motion picture. In some embodiments, the asset association module may be further configured to cause the association of the one of the asset identifiers and the motion picture identifier to be displayed on a device. In some embodiments, the asset association module may be further configured to store metadata about the asset for the one of the asset identifiers. In some embodiments, the metadata may comprise at least one of an origin of the asset, a price for the asset, and a usage history for the asset. In some embodiments, the motion picture may be a feature film or a television episode.

In some embodiments, a non-transitory machine-readable storage device may tangibly embody a set of instructions that, when executed by at least one processor, causes the at least one processor to perform a set of operations comprising causing a plurality of asset identifiers to be displayed on a device. Each asset identifier may identify a distinct asset available for use in a motion picture. The set of operations may also comprise enabling a user to associate one of the asset identifiers with a motion picture identifier, thereby forming an association between the one of the asset identifiers and the motion picture identifier. The motion picture identifier may identify the motion picture. The set of operation may further comprise storing the association between the one of the asset identifiers and the motion picture identifier on a storage device. In some embodiments, enabling the user to associate one of the asset identifiers with a motion picture identifier may comprise enabling the user to associate one of the asset identifiers with at least one structural element of the motion picture. In some embodiments, the at least one structural element may comprise at least one of a scene in the motion picture, an actor in the motion picture, and a location in the motion picture. In some embodiments, the set of operations may further comprise enabling a user to identify the at least one structural element of the motion picture. In some embodiments, the set of operations may further comprise causing the association of the one of the asset identifiers and the motion picture identifier to be displayed on a device. In some embodiments, the set of operations may further comprise storing metadata about the asset for the one of the asset identifiers. In some embodiments, the metadata may comprise at least one of an origin of the asset, a price for the asset, and a usage history for the asset. In some embodiments, the motion picture may be a feature film or a television episode.

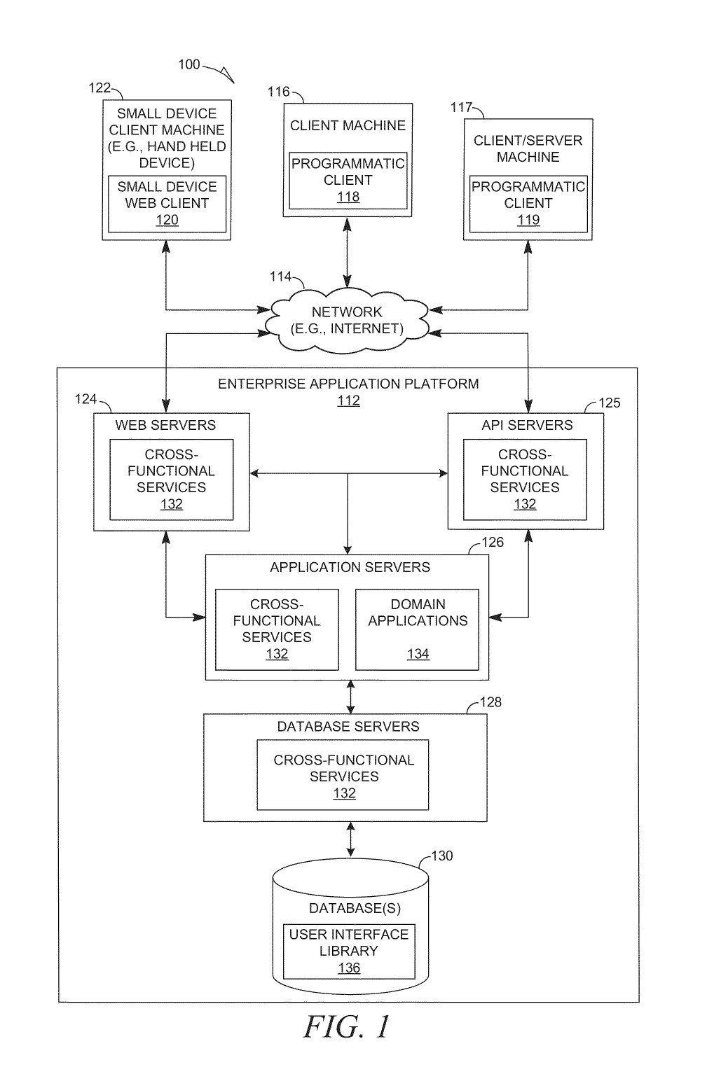

FIG. 1 is a network diagram illustrating a client-server system 100, in accordance with an example embodiment. A platform (e.g., machines and software), in the exemplary form of an enterprise application platform 112, provides server-side functionality, via a network 114 (e.g., the Internet) to one or more clients. FIG. 1 illustrates, for example, a client machine 116 (e.g., a laptop computer, a tablet computer, a smartphone, etc.) with programmatic client 118 (e.g., a browser, such as the INTERNET EXPLORER browser developed by Microsoft Corporation of Redmond, Wash. State), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 may be coupled to, and provide web and programmatic interfaces to, application servers 126. The application servers 126 may be, in turn, coupled to one or more database servers 128 that facilitate access to one or more databases 130. The web servers 124, Application Program Interface (API) servers 125, application servers 126, and database servers 128 may host cross-functional services 132. The application servers 126 further may host domain applications 134.

The cross-functional services 132 provide services to users and processes that utilize the information enterprise application platform 112. For instance, the cross-functional services 132 may provide portal services (e.g., web services), database services and connectivity to the domain applications 134 for users that operate the client machine 116, the client/server machine 117 and the small device client machine 122. In addition, the cross-functional services 132 may provide an environment for delivering enhancements to existing applications and for integrating third-party and legacy applications with existing cross-functional services 132 and domain applications 134. Further, while the system 100 shown in FIG. 1 employs a client-server architecture, the embodiments of the present invention are of course not limited to such an architecture, and could equally well find application in a distributed, or peer-to-peer, architecture system.

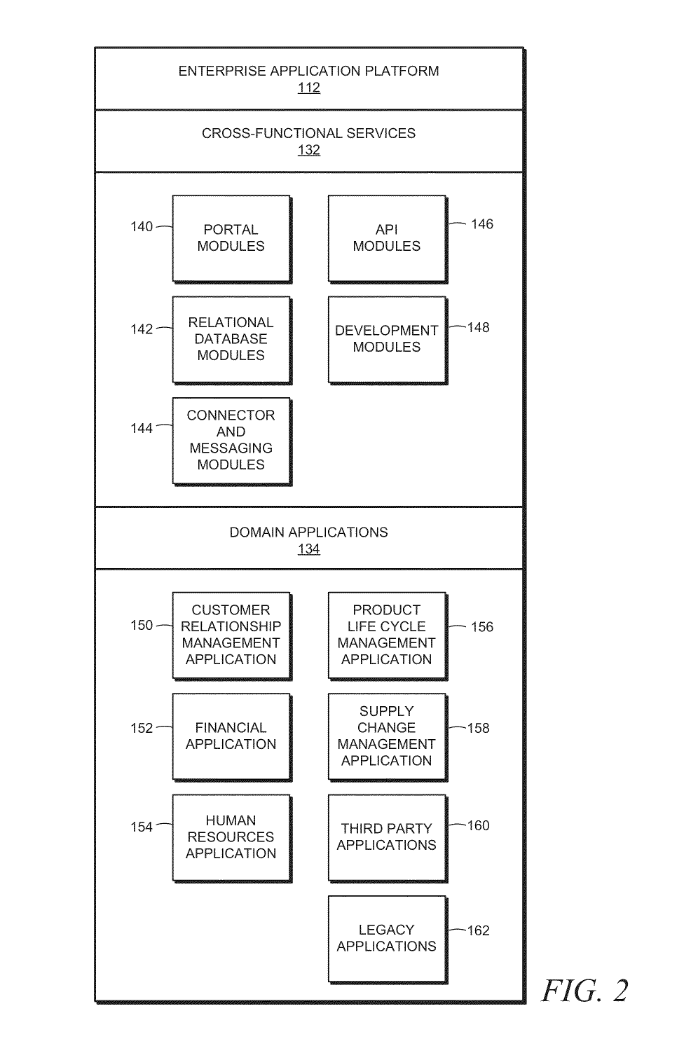

FIG. 2 is a block diagram illustrating enterprise applications and services as embodied in an enterprise application platform 112, in accordance with an example embodiment. The enterprise application platform 112 includes cross-functional services 132 and domain applications 134. The cross-functional services 132 may include portal modules 140, relational database modules 142, connector and messaging modules 144, Application Program Interface (API) modules 146, and development modules 148.

The portal modules 140 may enable a single point of access to other cross-functional services 132 and domain applications 134 for the client machine 116, the small device client machine 122 and the client/server machine 117. The portal modules 140 may be utilized to process, author and maintain web pages that present content (e.g., user interface elements and navigational controls) to the user. In addition, the portal modules 140 may enable user roles, a construct that associates a role with a specialized environment that is utilized by a user to execute tasks, utilize services and exchange information with other users and within a defined scope. For example, the role may determine the content that is available to the user and the activities that the user may perform. The portal modules 140 include a generation module, a communication module, a receiving module and a regenerating module. In addition the portal modules 140 may comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 may provide support services for access to the database 130, which includes a user interface library 136. The relational database modules 142 may provide support for object relational mapping, database independence and distributed computing. The relational database modules 142 may be utilized to add, delete, update and manage database elements. In addition, the relational database modules 142 may comply with database standards and/or utilize a variety of database technologies including SQL, SQLDBC, Oracle, MySQL, Unicode, JDBC.

The connector and messaging modules 144 may enable communication across different types of messaging systems that are utilized by the cross-functional services 132 and the domain applications 134 by providing a common messaging application processing interface. The connector and messaging modules 144 may enable asynchronous communication on the enterprise application platform 112.

The Application Program Interface (API) modules 146 may enable the development of service-based applications by exposing an interface to existing and new applications as services. Repositories may be included in the platform as a central place to find available services when building applications.

The development modules 148 may provide a development environment for the addition, integration, updating and extension of software components on the enterprise application platform 112 without impacting existing cross-functional services 132 and domain applications 134.

Turning to the domain applications 134, the customer relationship management application 150 may enable access to and may facilitate collecting and storing of relevant personalized information from multiple data sources and business processes. Enterprise personnel that are tasked with developing a buyer into a long-term customer may utilize the customer relationship management applications 150 to provide assistance to the buyer throughout a customer engagement cycle.

Enterprise personnel may utilize the financial applications 152 and business processes to track and control financial transactions within the enterprise application platform 112. The financial applications 152 may facilitate the execution of operational, analytical and collaborative tasks that are associated with financial management. Specifically, the financial applications 152 may enable the performance of tasks related to financial accountability, planning, forecasting, and managing the cost of finance.

The human resource applications 154 may be utilized by enterprise personal and business processes to manage, deploy, and track enterprise personnel. Specifically, the human resource applications 154 may enable the analysis of human resource issues and facilitate human resource decisions based on real time information.

The product life cycle management applications 156 may enable the management of a product throughout the life cycle of the product. For example, the product life cycle management applications 156 may enable collaborative engineering, custom product development, project management, asset management and quality management among business partners.

The supply chain management applications 158 may enable monitoring of performances that are observed in supply chains. The supply chain management applications 158 may facilitate adherence to production plans and on-time delivery of products and services.

The third-party applications 160, as well as legacy applications 162, may be integrated with domain applications 134 and utilize cross-functional services 132 on the enterprise application platform 112.

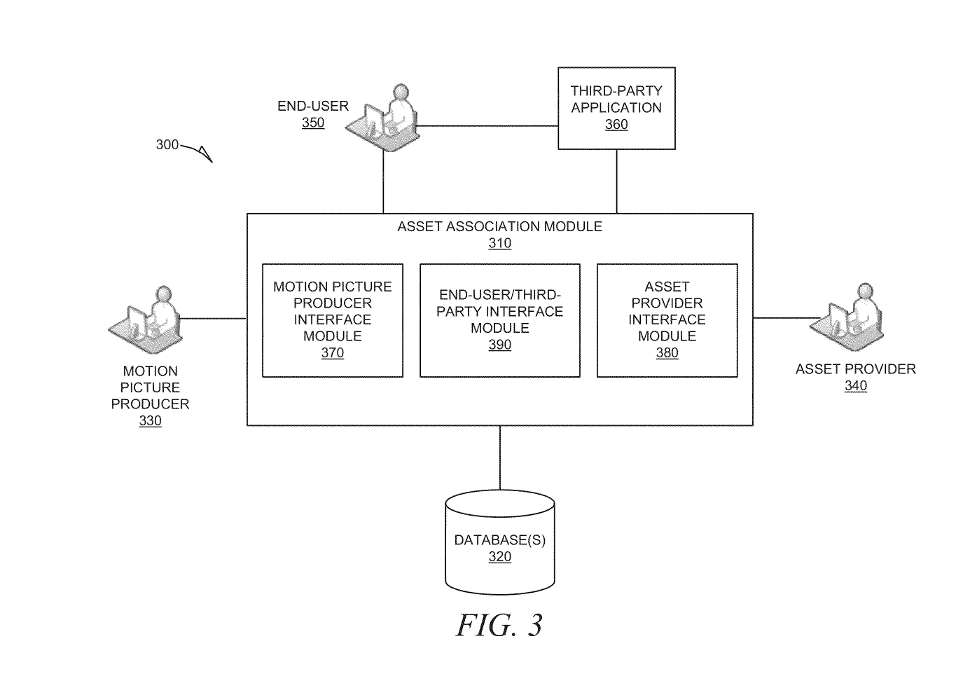

FIG. 3 is a block diagram illustrating an asset association system 300, in accordance with an example embodiment. The asset association system 300 may comprise an asset association module 310. In some embodiments, the asset association module 310 may reside on a machine having at least one processor. In some embodiments, the asset association module 310 may be incorporated into the enterprise application platform 112 of FIG. 1. In some embodiments, the asset association module 310 may be configured to cause a plurality of asset identifiers to be displayed on a device. As previously mentioned, an asset may comprise any product or service that can be seen or reflected in a motion picture. Examples of assets may include, but are not limited to, articles of clothing, shoes, accessories, furniture, locations (e.g., travel spots, spas, hairdressers), film sets, vehicles, consumer electronics, music, and other story details. It is contemplated that other assets are also within the scope of the present disclosure. Each asset identifier may identify a distinct asset available for use in a motion picture. In some embodiments, each asset identifier may comprise text and/or an image. As previously mentioned, the motion picture may comprise any visual media comprising a series of images configured to produce the optical effect of a continuous picture in which the objects move. Examples of a motion picture may include, but are not limited to, a feature film and a television episode. It is contemplated that other types of motion pictures are also within the scope of the present disclosure.

The asset association module 310 may also be configured to enable a user to associate one or more of the asset identifiers with a motion picture identifier, thereby forming an association between the asset identifier(s) and the motion picture identifier. The motion picture identifier may identify the motion picture, and may comprise text and/or an image. The asset association 310 module may be further configured to store the association between the asset identifier(s) and the motion picture identifier in one or more databases 320. In some embodiments, the one or more databases 320 may be incorporated into the one or more databases 130 of FIG. 1.

In some embodiments, enabling the user to associate the asset identifier(s) with a motion picture identifier may comprise enabling the user to associate the asset identifier(s) with at least one structural element of the motion picture. In some embodiments, a structural element of a motion picture may comprise any element that helps form a part of the motion picture. In some embodiments, the structural element(s) may comprise at least one of a scene in the motion picture, an actor in the motion picture, and a location in the motion picture. In some embodiments, the asset association module 310 may be further configured to enable a user to identify the structural element of the motion picture. In some embodiments, the asset association module 310 may be further configured to cause the association of the one of the asset identifiers and the motion picture identifier to be displayed on a device. In some embodiments, the asset association module 310 may be further configured to store metadata about the asset for the one of the asset identifiers. In some embodiments, the metadata may comprise at least one of an origin of the asset, a price for the asset, and a usage history for the asset.

It is contemplated that the associating and identifying actions discussed herein may be performed using any user input mechanism. For example, a user may associate an asset identifier with a motion picture identifier or with a structural element of a motion picture using a mouse or a touchpad. Additionally, a user may identify structural elements of a motion picture using a keyboard. It is contemplated that the use of other user input mechanisms are also within the scope of the present disclosure.

The asset association system 300 may be used to create a virtual marketplace for motion picture producers 330, asset providers 340, end users 350 (e.g., film viewers, buyers), and third party applications (e.g., film-streaming websites, Internet Protocol television networks, online stores). A motion picture producer 330 may upload metadata for assets used in a motion picture, as well as upload the motion picture itself (e.g., in the form of a digital media file), to the system 300, where it may be stored in the database(s) 320 and accessible via a virtual marketplace. The metadata for the assets may comprise information about the origin, current seller, price, and usage history of the assets. It is contemplated that other information about the assets may be uploaded and stored as well. In some embodiments, this information may be saved in a separate data package as the motion picture. In some embodiments, information about the assets may be linked to specific segments of the motion picture via timestamps. Information about assets may be linked to specific segments of the motion picture using other methods as well, including, but not limited to, the use of image information (e.g., identifying information about images in the motion picture).

An asset producer 340 may upload information about his or her products and/or services into the system 300, where it may be stored in the database(s) 320 and accessible via a virtual marketplace. The asset producer 340 may directly contact the motion picture producer 330 via the system 300 and make offers for user of the products and/or services for a future motion picture production.

An end user 350 may search the system 300 for certain items in a motion picture using one or more elements of the motion picture. For example, the end user 350 may perform a search for an actress in a motion picture to find the clothes that the actress wore in the motion picture. In some embodiments, the end user 350 may perform a search using even more specific metadata, such as by specifying a particular scene in the motion picture in order to find the clothes that the actress wore in that particular scene. Furthermore, in some embodiments, the end user 350 may register with the system 300 and receive real-time information about assets in a motion picture as the end user 350 is watching the motion picture. The motion picture may be provided to the end user 350 from the system 300 or from an external system (e.g., another website that provides streaming movies). In some embodiments, the information about assets in the motion picture may be displayed to the end user 350 on a second screen or a separate display area from the display of the motion picture while the motion picture is playing. As a particular scene is being played, information about assets being used in that particular scene may be displayed to the end user 350.

In some embodiments, the information about assets in the motion picture may be displayed in an integrated fashion with the display of the motion picture on the same screen on which the motion picture is being displayed. For example, a user may be watching a motion picture on a tablet computer and click on an asset (e.g., a shirt an actor is wearing) being displayed in the motion picture, which may cause the information about the selected asset to be displayed to the user. In some embodiments, the information about the assets in the motion picture may be displayed to the user on the same screen as the motion picture without the user having to select an asset. For example, the user may select an option (e.g., before or during the user's viewing of the motion picture) that enables the automatic display of information about assets in the motion picture to be activated. The user may configure the automatic display of asset information so that only information about certain types of assets (e.g., only clothes) is displayed automatically.

In some embodiments, the information about an asset may comprise a way for the user to purchase the asset. For example, the information displayed to the user may comprise a selectable link to a listing for the asset on a merchant site.

In some embodiments, the asset association module 310 may comprise a motion picture producer interface module 370, an asset provider interface module 380, and an end-user/third-party interface module 390. Each interface module may have its own login module or procedure for its intended users.

In some embodiments, the asset provider interface module 380 may be configured to enable asset providers 340 to perform operations on the asset association module 310. Asset providers 340 may be asset producers, asset stores, retailers, second-hand asset providers, and others from which assets may be obtained. In some embodiments, the asset providers can either enter their asset data (e.g., name, description, price, image) manually or connect their product database to the asset association module 310. Assets may be associated with an offer for motion picture producers 330. For example, an asset provider 340 may offer a product for free or at a discount. If a motion picture producer 330 chooses an asset for a specific motion picture, then the asset information may be linked to the motion picture, and this association may be made visible to end-users 350 through movie distribution channels. Asset providers 340 may query the asset association module 310 to gather information about which and how many of their items were viewed or sold.

In some embodiments, the motion picture producer interface module 370 may be configured to enable motion picture producers 330 to perform operations on the asset association module 310. In some embodiments, motion picture producers 330 can upload their scripts to the asset association module 310, where they may be stored in the one or more databases 320. The asset association module 310 may automatically identify structural elements of the motion picture by analyzing the script. Examples of these structural elements may include, but are not limited to, scenes, actors, and locations. In some embodiments, the asset association module 310 may be configured to recognize certain formatting or language in the script as an indication of a structural element. The asset association module 310 may be configured to create a corresponding view of the structural elements a motion picture. Motion picture producers 330 may then access this structured information and match it with the offers from asset providers 340. Once they find a suitable asset, motion picture producers 330 may attach it to the corresponding structural elements (e.g, an actor and a scene). In some embodiments, an offer or order for the asset may then be sent to the asset provider 340.

In some embodiments, the information about the mapping of assets to motion pictures may be presented to a wide audience via third party applications 360. These third party applications 360 may include web and mobile applications. The information about the associations between assets and motion pictures may be presented via web and mobile API's. Web or mobile applications (e.g., film streaming websites or online shops) may use one or more APIs of the asset association module 310 to expose this information to end-users 350. Conversely, statistics about end-user interactions and behavior may also be sent from the third party applications 360 to the motion picture producers 330 and asset providers 340.

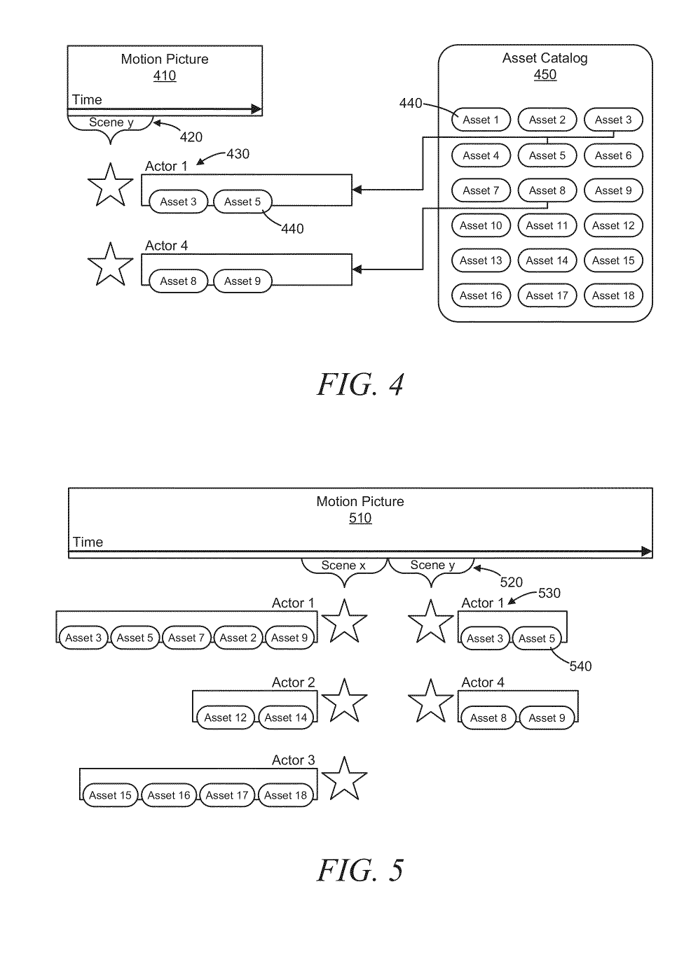

FIG. 4 illustrates an example embodiment of mapping assets to a scene of a motion picture. A motion picture identifier 410 may be presented to a user (e.g., motion picture producer 330). The motion picture identifier 410 may be configured to identify the motion picture and may comprise text and/or an image. In some embodiments, the motion picture identifier 410 may comprise a representation of time corresponding to the motion picture. Representations of structural elements of the motion picture may also be presented to the user. These structural elements may include, but are not limited to, one or more scenes 420 and one or more actors 430. The representations of the structural elements may comprise text and/or an image.

An asset catalog 450 may be presented to the user. The asset catalog 450 may comprise representations of available assets 440 of a single asset provider or multiple asset providers. The representations of the available assets 440 may comprise text and/or an image. The user may select one or more available assets 440 to be used in the motion picture. The selected assets 440 may then be assigned to the motion picture 410. As previously discussed, certain assets 440 may be assigned to particular structural elements. For example, in FIG. 4, Asset 3 and Asset 5 may be assigned to Actor 1 in Scene y, while Asset 8 and Asset 9 may be assigned to Actor 4 in Scene y. In some embodiments, the user may select an asset for a motion picture or for a structural element of a motion picture using any suitable user input mechanism (e.g., clicking, tapping, dragging, etc.). In some embodiments, once the asset provider 340 accepts the offer or processes the order for any selected assets 440, the information about the selected assets 440 may be permanently mapped to the motion picture and viewable by users (e.g., a user who is watching the motion picture and wants to find out details about an asset in a particular scene). The assets 440 may be mapped to a particular scene, segment, and/or time of the motion picture. For example, in some embodiments, timestamps may be used to associate assets 440 with structural elements of the motion picture and to facilitate discovery of the assets 440 by viewers of the motion picture.

FIG. 5 illustrates an example embodiment of assets mapped to a motion picture. In some embodiments, for each scene 420 of the motion picture and each appearing actor 430 in that scene, the system may make the associated list of assets 440 visible to users. As seen in FIG. 5, multiple scenes 420 may be mapped to and represented. The representations of the multiple scenes may be displayed in an order corresponding to their timing of the scenes in the motion picture. For example, Scene x may be displayed to the left of Scene y in order to represent the fact that Scene x takes place before Scene y. It is contemplated that other timing information may be displayed as well, including, but not limited to, start times for scenes. Furthermore, detailed information may be available for each individual asset 540. In some embodiments, end users may have access to this attached information. For example, a use may select Asset 12, which is associated with Actor 2 in Scene x, to find out detailed information about Asset 12. This information may include, but is not limited to, its corresponding asset provider, its price, and its usage history.

It is contemplated that FIGS. 4 and 5 may serve as examples of how mappings of assets to motion pictures may be functionally implemented in a system (e.g., in a database), as well as how these mappings may be displayed to users. In some embodiments, an application is provided that visualizes the mapped information so that viewers of the motion picture may see the information. In some embodiments, a viewer of the motion picture may view the motion picture and associated asset information in separate displays (e.g., separate screens or separate windows) simultaneously in real-time. In some embodiments, the asset information associated with the motion picture may not be part of the actual motion picture file being viewed, but may be part of a separate data package that is linked to the motion picture file. In some embodiments, the asset information may be linked to the actual motion picture file via timestamps. In some embodiments, motion picture identifier 410 in FIGS. 4 and 5 may represent the actual motion picture file (e.g., a movie file configured to be played). In some embodiments, the viewer of the motion picture may access the associated asset information by browsing/searching a website that has access to the information. In this fashion, the viewer may not be viewing the asset information as the motion picture is playing or as the corresponding scene for the associated asset information is playing, but rather may view this information upon his or her prompting.

In some embodiments, the motion picture producers may give away the assets used in the motion picture to viewers. For example, a jacket worn by a popular actress in a special scene of a film may be given away to viewers. The viewers can like, comment on, and win the offered assets (e.g., by using a web site that enables these features). This may help motion picture producers to free up storage space in their studios and connect more strongly with their viewers.

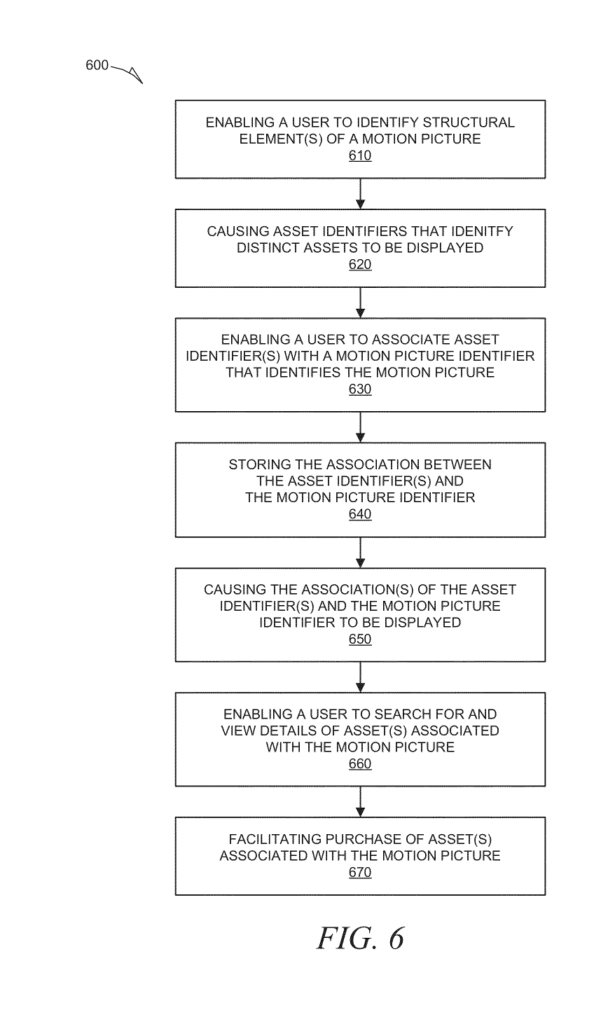

FIG. 6 is a flowchart illustrating an example embodiment of an asset association method 600. At operation 610, a user may be enabled to identify one or more structural elements of a motion picture using a device. In some embodiments, the user may upload a script of the motion picture, which may then be automatically analyzed and from which the structural elements may be identified. In some embodiments, the user may enter the structural elements using a user input mechanism (e.g., a keyboard). At operation 620, asset identifiers may be caused to be displayed on a device. The asset identifiers may identify distinct assets available for use in the motion picture. At operation 630, a user may be enabled to associate, using a device, one or more asset identifiers with a motion picture identifier that identifies the motion picture, thereby forming one or more associations between the asset identifier(s) and the motion picture identifier. In some embodiments, the user may be enabled to associate the asset identifiers with one or more structural elements of the motion picture. The association(s) between the asset identifier(s) and the motion picture identifier may comprise one or more associations between the asset identifier(s) and the structural element(s) of the motion picture. At operation 640, the association(s) between the asset identifier(s) and the motion picture identifier may be stored in a storage device. At operation 650, the association(s) between the asset identifier(s) and the motion picture identifier may be caused to be displayed on a device. At operation 660, a user may be enabled to search for and view details of one or more assets associated with the motion picture using a device. At operation 670, the purchase of assets of the motion picture may be facilitated. For example, in some embodiments, the user may be enabled to place assets in an electronic shopping cart and then go through a checkout procedure. In some embodiments, the user may be directed to a supplier of any assets he or she is interested in purchasing. It is contemplated that any of the features disclosed within the present disclosure may be incorporated into the asset association method 700.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

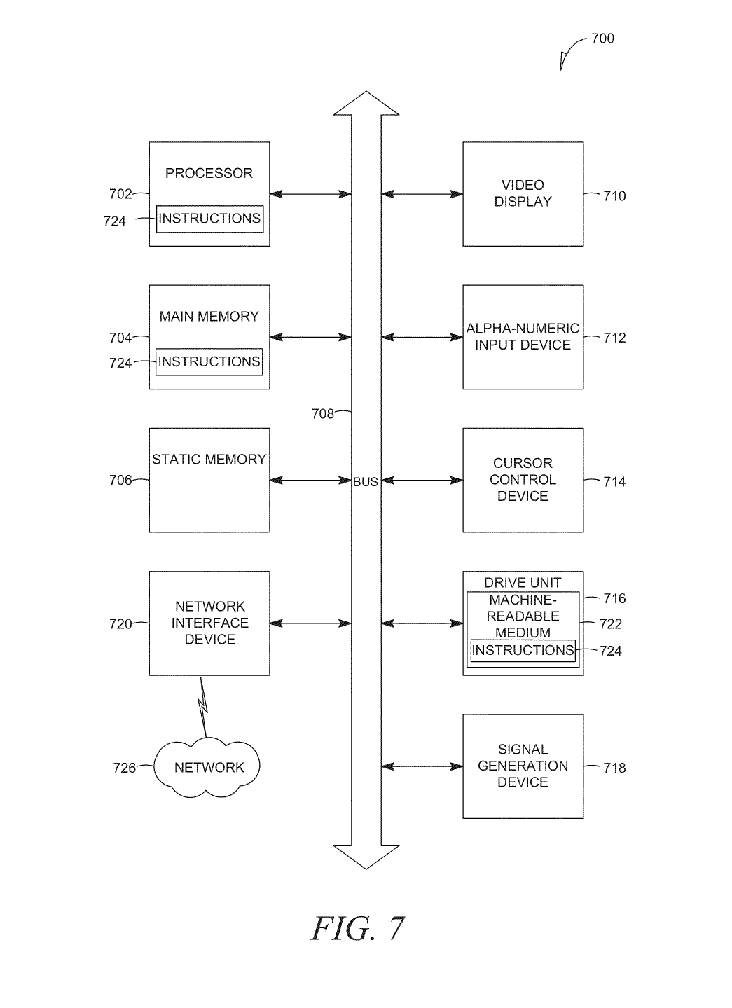

FIG. 7 is a block diagram of a machine in the example form of a computer system 700 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
causing a plurality of asset identifiers to be displayed on a device, each asset identifier identifying a distinct asset available for use in a motion picture;
enabling a user to associate one of the asset identifiers with a motion picture identifier, forming an association between the one of the asset identifiers and the motion picture identifier, the motion picture identifier identifying the motion picture; and
storing the association between the one of the asset identifiers and the motion picture identifier on a storage device.

2. The method of claim 1, wherein enabling the user to associate one of the asset identifiers with a motion picture identifier comprises enabling the user to associate one of the asset identifiers with at least one structural element of the motion picture.

3. The method of claim 2, wherein the at least one structural element comprises at least one of a scene in the motion picture, an actor in the motion picture, and a location in the motion picture.

4. The method of claim 2, further comprising enabling a user to identify the at least one structural element of the motion picture.

5. The method of claim 2, further comprising automatically identifying the at least one structural element of the motion picture by analyzing a script uploaded by the user, wherein formatting or language is used as an indication of the at least one structural element.

6. The method of claim 1, further comprising enabling a different user to search for and view details of the distinct assets corresponding to the asset identifiers.

7. The method of claim 1, further comprising causing the association of the one of the asset identifiers and the motion picture identifier to be displayed on a device.

8. The method of claim 1, further comprising storing metadata about the asset for the one of the asset identifiers.

9. The method of claim 8, wherein the metadata comprises at least one of an origin of the asset, a price for the asset, and a usage history for the asset.

10. The method of claim 1, wherein the motion picture is a feature film or a television episode.

11. A system comprising:
a machine having at least one processor; and
an asset association module on the machine and configured to:
cause a plurality of asset identifiers to be displayed on a device, each asset identifier identifying a distinct asset available for use in a motion picture;
enable a user to associate one of the asset identifiers with a motion picture identifier, forming an association between the one of the asset identifiers and the motion picture identifier, the motion picture identifier identifying the motion picture; and
store the association between the one of the asset identifiers and the motion picture identifier on a storage device.

12. The system of claim 11, wherein enabling the user to associate one of the asset identifiers with a motion picture identifier comprises enabling the user to associate one of the asset identifiers with at least one structural element of the motion picture.

13. The system of claim 12, wherein the at least one structural element comprises at least one of a scene in the motion picture, an actor in the motion picture, and a location in the motion picture.

14. The system of claim 12, wherein the asset association module is further configured to enable a user to identify the at least one structural element of the motion picture.

15. The system of claim 11, wherein the asset association module is further configured to cause the association of the one of the asset identifiers and the motion picture identifier to be displayed on a device.

16. The system of claim 11, wherein the asset association module is further configured to store metadata about the asset for the one of the asset identifiers.

17. The system of claim 16, wherein the metadata comprises at least one of an origin of the asset, a price for the asset, and a usage history for the asset.

18. The system of claim 11, wherein the motion picture is a feature film or a television episode.

19. A non-transitory machine-readable storage device, tangibly embodying a set of instructions that, when executed by at least one processor, causes the at least one processor to perform a set of operations comprising:
causing a plurality of asset identifiers to be displayed on a device, each asset identifier identifying a distinct asset available for use in a motion picture;
enabling a user to associate one of the asset identifiers with a motion picture identifier, forming an association between the one of the asset identifiers and the motion picture identifier, the motion picture identifier identifying the motion picture; and
storing the association between the one of the asset identifiers and the motion picture identifier on a storage device.

20. The device of claim 17, wherein enabling the user to associate one of the asset identifiers with a motion picture identifier comprises enabling the user to associate one of the asset identifiers with at least one structural element of the motion picture.
